(19) United States
(12) Patent Application Publication
(10) Pub. No.: US 2006/0282269 A1
(43) Pub. Date: Dec. 14, 2006

(54) Universal translator

(76) Inventor: Barry H. Galison, DelRay Beach, FL (US)

Correspondence Address: Galasso & Associates, LP, P.O. Box 26503, Austin, TX, 78755-0503, US

(21) Appl. No.: 11/147,704

(22) Filed: Jun. 8, 2005

(51) Int. Cl. G10L 11/00

(52) U.S. Cl. 704/277

(57) ABSTRACT

The universal translator is a hand held device operable to receive voice communication, translate said communication to another language and return a voice communication in the designated language. It contains a micro chip operable to determine the language of the input voice communication and micro chip operable to determine the language of the voice output communication. The universal translator comprises at least one set of micro chips for the various languages thereby allowing someone traveling from one county to another to change out the micro chips based on the language of the country and/or area of the country.

### TECHNICAL FIELD

The present invention relates to a hand held device capable of translating a voice communication from one language to another and providing a voice communication of the original message in the designated language.

### BACKGROUND

As trade barriers continue to decline more and more business is being done in different countries. We have also become a more mobile society and parts of the world are becoming less dangerous for travel. As a result language differences have played a bigger part in our travels. It is very difficult to conduct business in another part of the world when the parties involved all speak a different language. Although translators are an option, they can be very expensive and it is sometime difficult to be sure that they are actually conveying your message in proper context and with proper emphasis. Translators are not always readily available when you need them as well. For example, it is not cost efficient to have a translator accompany you during an entire business trip to make sure that you can communicate with the anyone you may come in contact, i.e. the hotel clerk, the taxi driver. In addition, people are traveling from one country to another more on vacation than in the past. This too presents problems as far as language difficulties.

There are lots of study courses out that would allow an individual to learn another language. However, it is not always practical to do so. Although some of these courses can be learned in the privacy of one's own home, it still requires a certain amount of time commitment and again these courses are not always affordable to every individual. Otherwise, one would have to commit to a class schedule where they would also get interaction with other people attempting to learn the language. But what happens if all of the sudden you are going on a business trip where you will travel to several different countries none of which speak the same language? You must also continue to use a language on a regular basis in order to maintain the knowledge of the language and the ability to speak it.

Therefore, the present invention is an alternative to the problems faced by the various scenarios of language barriers. The present invention does not require any long term time commitments and would be readily available to every individual who had a need to be able to converse in at least one other language.

### SUMMARY

In one embodiment the universal translator would be a hand held device operable to function as a language translation device.

In another embodiment the universal translator would be operable to receive voice communication from an individual.

In another embodiment the universal translator would be operable to transmit voice communication.

In yet another embodiment the universal translator would be operable to receive a voice communication and translate said voice communication from one language to another.

In still another embodiment the universal translator would contain a microprocessosr operable to receive said voice communication for translation.

In yet another embodiment the universal translator would comprise a set of language micro chips.

In another embodiment the universal translator would contain an instrument for inserting micro chips operable to recognize the language of the voice communication.

In yet another embodiment the universal translator would contain an instrument for inserting micro chips operable to determine the language for which the voice communication would be translated.

In another embodiment the universal translator would be operable to function off of varying power sources.

In another embodiment the universal translator would be operable to adjust the volume.

Still other advantages of various embodiments will become apparent to those skilled in this art from the following description wherein there is shown and described preferred embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is an elevational view of the universal translator.

FIG. 2 in an internal view of the universal translator depicting the microprocessor.

FIG. 3 is a view of the back of the universal translator showing the power sources.

FIG. 4 is a front view of the micro chip input and micro chip output device.

FIG. 5 is an open view of the carrying case for the micro chips and the micro chips.

### DETAILED DESCRIPTION OF THE PREFERRED EMBODIMENT

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

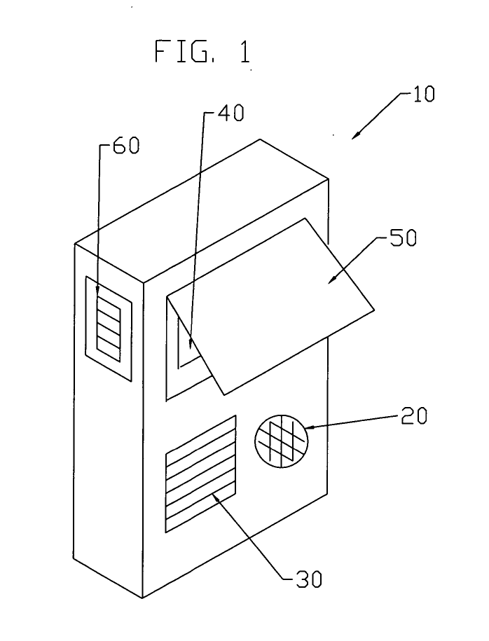

FIG. 1 depicts a hand held device 10 operable translate voice communications received and output voice communications based on the specified language. The hand held device 10 comprises a microphone 20, a speaker 30, a micro chip compartment 40, a hinged chip access cover 50 to protect the micro chips 130, a volume control 60.

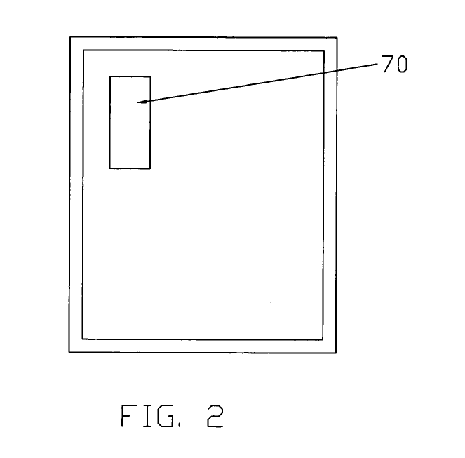

FIG. 2 depicts the inside of the hand held device 10, wherein the microprocessor 70 operates to receive a voice communication, determine the language of the voice communication based on the micro chips inserted into the micro chip compartment 40. The microprocessor 70 then uses the micro chips to determine the language for the output voice communication. Once the microprocessor 70 has made the appropriate determination of the input and output languages it processes the information. The microprocessor 70 would then convert the voice communication from the designated input language to the designated output language. After appropriate processing has taken place and the voice communication has been converted, the microprocessor 70 outputs a voice communication in the appropriately designated language. The microprocessor 70 will continue to process input voice communications and output the information until the hand held device 10 is turned off. The language input and output can be easily changed by changing out the micro chips.

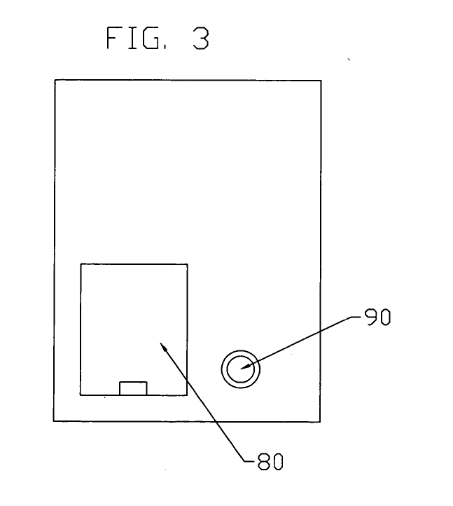

FIG. 3 is a view of the back of the hand held device 10, wherein you are able to see the power source options. In one embodiment, the battery compartment 80 would hold batteries which would allow for power to the hand held device 10. Alternatively, the hand held device 10 comprises an adapter plug 90 which would allow for the hand held device to be plugged into an electrical power source. Additionally, the hand held device could be equipped with a rechargeable battery similar to those used on cell phones.

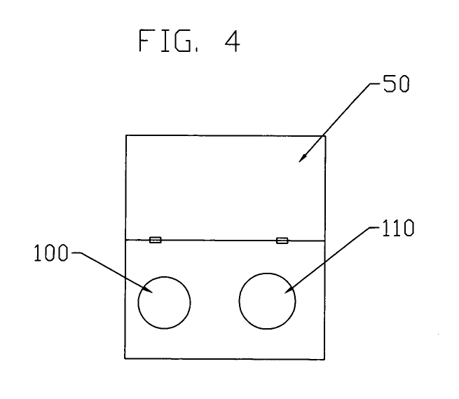

FIG. 4 depicts the micro chip compartment 40 of the hand held device 10, wherein the various language micro chips 130 are placed. The voice input micro chip tray 100 would contain the micro chip that would determine the language of the input voice communication. The voice output micro chip tray 110 would contain the micro chip that operates to determine the language of the voice output communication. The hinged chip access cover 50 is used to protect the micro chip compartment 40, as well as the micro chips 130 themselves, when they are inserted into the hand held device 10.

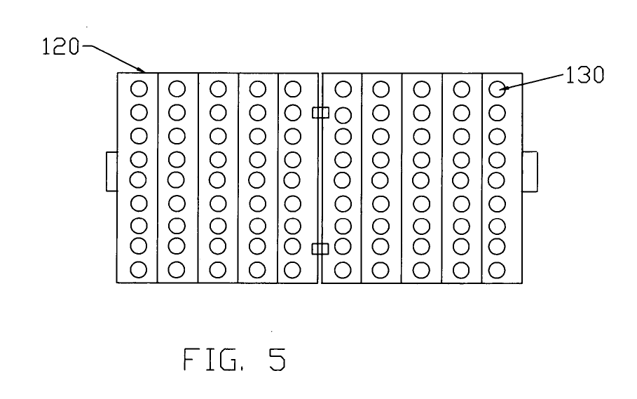

FIG. 5 depicts the carry case 120 that contains the language micro chips 130. The micro chips 130 are used to determine the voice input and voice output communication languages.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed:

1. A hand held device comprising:
a housing,
said housing having a hinged door on the top side wherein micro chips are inserted;
a button for record button; and
a message output button.

2. A hand held device of claim 1, wherein the housing contains a microprocessor.

3. A hand held device of claim 1, further comprising a micro chip input device.

4. A hand held device of claim 3, wherein the micro chip contains designated language information for translating the received voice communication.

5. A hand held device of claim 3, wherein the micro chip contains designated language information for outputting voice communication in the designated language.

6. A hand held device of claim 1, further comprising a microphone operable to receive voice communications.

7. A hand held device of claim 1, further comprising a speaker operable output voice communications.

8. A hand held device of claim 1, wherein the microprocessor is operable to retrieve the designated language from the micro chip input device.

9. A hand held device of claim 8, wherein the microprocessor is operable to receive voice communications from the microphone.

10. A hand held device of claim 8, wherein the microprocessor receives voice communication and converts that communication to a designated language.

11. A hand held device of claim 8, wherein the microprocessor is operable to output voice communications through a speaker.

12. A hand held device comprising:
at least one set of micro chips which contain various languages; wherein the microprocessor can convert voice communication from one language to another based upon the languages on the micro chips; and
a battery compartment operable to supply power.

13. A hand held device of claim 12, wherein the micro chip would cause the microprocessor to process voice communication based on the language received.

14. A hand held device of claim 12, wherein the micro chip would cause the microprocessor to output voice communication in another language based on the output micro chip language assigned.

15. A hand held device comprising:
housing containing a microprocessor, wherein the microprocessor can convert voice communication from one language to another based upon the languages on the micro chips;
a record button;
a message output button;
a microphone for receiving voice communication;
a speaker for outputting voice communication;
a volume control switch;
at least two micro chip trays operable to determine the input language and output language;
a hinged chip access cover;
a carry case for the language micro chips; and
at least one set of language micro chips.

16. A hand held device of claim 15, further comprising a battery compartment.

17. A hand held device of claim 15, further comprising an electrical power supply device.

18. A hand held device of claim 15, further comprising a recharging device.
